(19) United States
(12) Patent Application Publication
(10) Pub. No.: US 2025/0284893 A1
(43) Pub. Date: Sep. 11, 2025

(54) MACHINE LEARNING SYSTEMS FOR VIRTUAL ASSISTANTS

(71) Applicant: ICS.AI LTD, Lychpit (GB)

(72) Inventors: Martin Neale, Heckfield (GB); Rahim Bayjou, Basingstoke (GB)

(21) Appl. No.: 18/700,840

(22) PCT Filed: Oct. 15, 2021
(86) PCT No.: PCT/EP2021/078722

§ 371 Date: Apr. 12, 2024

(51) Int. Cl. G06F 40/35; G06F 16/3329

(52) U.S. Cl. CPC G06F 40/35; G06F 16/33295

(57) ABSTRACT

A virtual assistant platform implemented by a computer system comprising: one or more hardware processors configured to execute computer readable instructions; one or more memory storing the instructions; a mapping data structure stored in the one or more memory, the mapping data structure mapping a plurality of intents to respective client specific actions; a network interface configured to receive a query from a user device operating in a client specific communication session with a virtual assistant in a first context, the instructions when executed providing: an AI language model comprising a client specific language model, the client specific language model having been trained on client specific data, and a mesh language model, the mesh language model having been trained on mesh specific data, the mesh specific data having been received by operating multiple virtual assistants in the first context, the AI language model being responsive to the query to generate an intent; a mapping function to apply the intent to the mapping data structure and access a corresponding client specific action for delivery of a response to the user device; and a transmission function to transmit the response to the user device.

### FIELD

The present description relates to training machine learning systems and particularly but not exclusively to training and using natural language artificial intelligent models which are intended to operate user interfaces of virtual assistants (sometimes referred to as chatbots).

### BACKGROUND

Virtual assistants are increasingly used in a wide variety of contexts for conversing with humans via a human machine interface. A user speaks an instruction or types an instruction or question into a user interface, and the chatbot responds with user intelligible text or audio. There are different mechanisms for training machine learning systems that operate the natural language processing models which deliver responses to such human machine interfaces.

As an example of one such learning model, FIG. 1A shows a centralised learning model 100. A centralised learning model 100 comprises a single common code base which implements the AI language model for a large set of users 110. The training data set for the common code base is then the interactions of the set of users 110 with the AI language model. This training is highly effective in contexts in which a very large number of users 110 seek to accomplish similar tasks. However, the centralised learning model 100 can only handle generic queries common to all users 110; the common code base cannot be used to accomplish specialist tasks appropriate for a certain subset of users 110.

An example of a type of learning model for an AI assistant which is appropriate for specialist tasks is a Stand Alone model 120, shown in FIG. 1B. In a Stand Alone model 120 the AI assistant used by an organisation is unique to that organisation. The underpinning leaning model is therefore only trained on interactions with the users 110 of that organisation's AI assistant. This set of users 110 necessarily comprises a smaller group of users 110 than that available to a centralised learning model 100, which accomplishes common generic tasks as opposed to the specialised tasks of a specific organisation's AI assistant. The limited set of training data results in Stand Alone models 120 typically failing to offer a human parity experience to users 110. Furthermore, commercially available Stand Alone models 120 are typically provided without any prior training; the models must be trained locally on the limited pool of an organisation's data.

Existing learning models for AI assistants do not meet the needs of individual organisations because in order to achieve a human parity level of useability, large amounts of training data are needed, which is difficult or impossible to provide from a single standalone organisation. Furthermore, in order to collect AI training data from an assistant it must first have been trained with a subset of what is needed, meaning the initial useability is likely to be poor.

Indeed, Stand Alone models 120 are typically trained once and then deployed without further training after going to production. Since there is no continuous learning mechanism to improve them, the models are only ever as effective as they were at deployment time, so gaps in performance against constantly new and changing inputs are bound to occur.

### SUMMARY

The inventors seek to address these and other limitations of existing AI assistants. They have recognised that current learning models do not provide an ongoing method for training intents and variances within an organisational AI assistant model. One aim of the present embodiments is to improve the human-machine interface when a human user is engaging with a virtual assistant to perform a task.

According to an aspect of the present invention there is provided a virtual assistant platform implemented by a computer system comprising:
one or more hardware processors configured to execute computer readable instructions;
   one or more memory storing the instructions;
a mapping data structure stored in the one or more memory, the mapping data structure mapping a plurality of intents to respective client specific actions;
a network interface configured to receive a query from a user device operating in a client specific communication session with a virtual assistant in a first context, the instructions when executed providing: an AI language model comprising
   a client specific language model, the client specific language model having been trained on client specific data, and
   a mesh language model, the mesh language model having been trained on mesh specific data, the mesh specific data having been received by operating multiple virtual assistants in the first context, the AI language model being responsive to the query to generate an intent;
   a mapping function to apply the intent to the mapping data structure and access a corresponding client specific action for delivery of a response to the user device; and a transmission function to transmit the response to the user device.

The AI language model may comprise a generic language model, the generic model having been trained on general, non context-specific data, the non context-specific data having been received from multiple virtual assistants operating in different contexts.

The AI language model may comprise an ethics model trained to recognise queries requiring an ethics response.

The AI language model may comprise a small talk model trained to recognise queries relating to small talk.

The computer readable instructions may, when executed, provide a data extraction function which accesses query related data stored in a logging database and removes any personal identifiers from the data to provide anonymised data.

The computer readable instructions may, when executed, provide a data storage function which stores the anonymised data in a mesh data pool specific to the first context.

The computer readable instructions may, when executed, extract data from a plurality of logging databases, each logging database holding data specific to a client, the clients all belonging to the first context.

The computer readable instructions may, when executed, cause data to be extracted from a second plurality of logging databases, each logging database of the second plurality being associated with clients operating in a second context, and to store anonymised data from the second plurality of logging databases in a second mesh data pool.

The computer readable instructions may, when executed, provide an analytics function which analyses the anonymised data in the one or more mesh data pool, determines when retraining of the mesh language model is required and, when determined, causes the mesh language model to be retrained and updated; retrained and updated mesh language models may then be shared with other instances of the virtual assistant for the same mesh.

Another aspect of the present invention provides a method of configuring a set of virtual assistants assigned to a common context and operating at different client locations, the method comprising:
monitoring operation of the set of virtual assistants, each virtual assistant configured to receive a query from a user and generate an intent derived by natural language processing of the query, by a client specific machine learning model and a context specific machine learning model, the client specific model having been trained on client specific data while operating at a client location, and the context specific model having been trained on context specific data received from multiple virtual assistants operating in the context;
detecting one or more anomaly from one or more of the virtual assistants;
categorising the anomaly; and
retraining the context specific machine learning model to remove the anomaly; and
delivering the retrained context specific machine learning model to each of the set of virtual assistants.

The method may further comprise configuring a second set of virtual assistants operating in a second common context, the method comprising:
operating the virtual assistants of the second set in the second context;
   determining one or more anomaly from one or more of the virtual assistants of the second set;
   categorising the one or more anomaly detected from the virtual assistants of the second set;
   retraining a second context specific machine learning model specific to the second common context to remove the anomaly; and
   delivering the retrained second context specific machine learning model to each of the second set of virtual assistants.

The method may further comprise the step of monitoring operation of the first and second sets of virtual assistants comprising logging user queries in association with responses from the respective virtual assistant models for each context, and generating a first dataset of queries and responses for the first context and a second dataset of queries and responses for the second context of virtual models.

The method may further comprise, prior to the step of delivering the retrained context specific machine learning model, the step of providing a candidate update to a client location and receiving selection of one or more candidate updates from the client location.

The method may further comprise each virtual assistant comprising an ethics module configured to manage the ethical behaviour of the virtual assistant.

The method may further comprise categorisation of the anomaly comprising detecting that there has been an ethical breach.

The method may further comprise that the step of categorising an anomaly comprises identifying that frustration of a user has been detected by natural language processing of the user queries.

The method may further comprise each virtual assistant model comprising a generic model, the generic model having been trained on general non context-specific data received from multiple virtual assistants operating in different contexts.

According to one related aspect there is provided a method comprising receiving a request to instantiate a context specific virtual assistant;

delivering a context specific virtual assistant comprising a generic model, the generic model having been trained on general non context-specific data received from multiple virtual assistants operating in different contexts and a context specific model; and training the instantiated virtual assistant on client specific data.

The method may further comprise allocating the instantiated virtual assistant to at least one of a horizontal mesh and a vertical mesh, the vertical mesh comprising a plurality of industry specific contexts and the horizontal mesh comprising a plurality of function specific contexts.

### BRIEF DESCRIPTION OF THE DRAWINGS

For a better understanding of the present invention and to show how the same may be carried into effect, reference will now be made by way of example to the accompanying drawings.

FIG. 1A displays a representation of a connected learning model for a virtual assistant.

FIG. 1B displays a representation of a Stand Alone learning model for a virtual assistant.

FIG. 1C illustrates an example user interface for a virtual assistant.

FIG. 2A displays a smart mesh network comprising multiple smart meshes.

FIG. 2B illustrates a smart mesh network comprising vertical meshes and horizontal meshes.

FIG. 3 displays a representation of the relationship between the centralised smart mesh data pool and client AI language models belonging to a given smart mesh.

FIG. 4A presents a schematic illustration of the architecture of a virtual assistant platform utilising a smart mesh client AI language model.

FIG. 4B displays example relationships between intents and actions stored in the intent map of a virtual assistant platform.

FIG. 5A displays the processes utilised in the anomaly detection function of a virtual assistant platform.

FIG. 5B displays example data stored in the event database of a virtual assistant platform.

FIG. 6 provides a flowchart illustrating the steps followed upon detection of an anomaly.

FIG. 7 provides a flowchart illustrating the steps followed to update a client AI language model upon detection of an anomaly.

### DETAILED DESCRIPTION OF THE PREFERRED EMBODIMENTS

The present inventors have devised a system and technique for significantly speeding up a training process for AI assistants, and reducing the amount of data which is required to effectively train such assistants. In doing so, they have recognised that a typical virtual assistant in a particular context covers a wide range of inputs from a human user. These range from the generic (“Good morning”, “Hello”, “Can you help me?”) all the way to the specific for a particular organisation, for example “What does error code 308 mean?”. As described above, one type of existing technique for training treats the problem as a very large generic problem under which all specific matters will be dealt with. Another technique looks at the problem from the specific end itself, where each model is individually trained in its own specific context using context specific data.

The present inventors have introduced an intermediate context-based layer to improve training. This layer is referred to herein as a mesh layer or smart mesh.

The present inventors have also devised an improved virtual assistant platform for delivering and training AI assistants in multiple contexts.

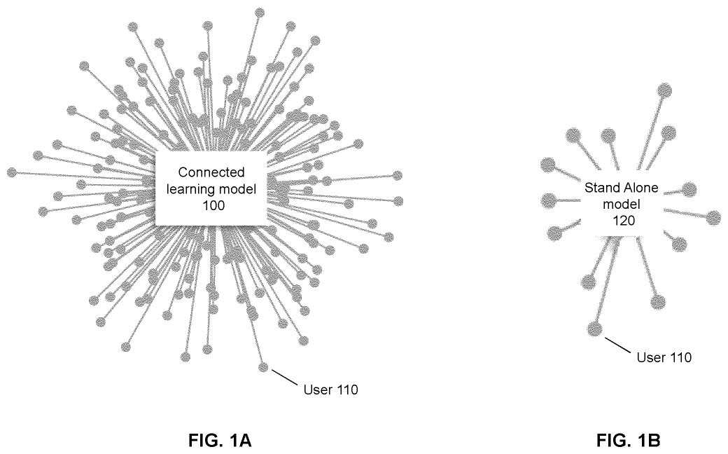

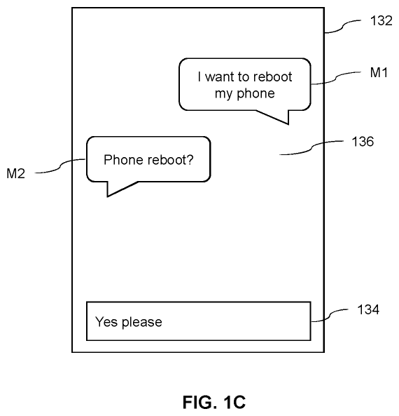

FIG. 1C shows a display of a user interface 132 at a user device deploying a virtual assistant (“chatbot”). The user device may be any suitable computer device having one or more processor configured to execute computer readable instructions stored in computer memory at the device. The user device has a user interface which provides a display and a user input means. An input text field 134 is provided on the display to receive input text from a user in the form of a query or user request. Note that this input could be entered into the input field by a user typing using a keyboard, using tracking on a surface pad of any kind, by audio input speech converted to text or any other way. When a user has finished his input message, he initiates a send function (for example, by pressing enter on a user keyboard) and then that message is displayed in a display area 136 of the display. In this particular example, the user has already typed in “I want to reboot my phone” and this is displayed as a first message M1 in the display area. The virtual assistant processes the message in a manner which will be described later and, in this case, correctly ascertains the intent derived from the message. The virtual assistant issues a response for user confirmation. In this case, the response is shown as message M2 in the display area “Phone reboot?”. This could be phrased in any number of ways, depending on the client's service which is offering support for phones. As can be seen in FIG. 1C, the user confirms this by typing into the input field 134 “Yes, please”. Now that the intent has been confirmed, an action can be taken at the client side based on the derived intent. For example, in this case, an action may be to provide information to the user about how to reboot their phone, either through the virtual assistant or directly to the phone itself, depending on the support which is provided. As noted herein, the action taken could comprise physical actions, such as routing a request to another virtual assistant, routing a request to a human or transmitting a selectable option to the user device, for example in the form of a user actuatable button or link which, when actuated, provides further services to a user. In one embodiment, a call button to a particular location may be provided based on an intent.

A message typed in by a user is processed using natural language processing. Various techniques are available to extract meaning from language. According to one technique, the text which is entered by the user is tokenised based on individual words and a grammatical context for the words, and then processed by a natural language processing model. In the present case, this is an AI (artificial intelligence) model which has been trained to classify token sequences into intents. That is, the training data for the AI model comprises annotated queries, each query being annotated with an intent label. The AI model is trained by running it to classify queries into intents, using supervised feedback to indicate when the model has correctly classified an intent label. This is distinct from the way in which NLP models are normally trained and used-previously, the NLP model is trained to recognise and classify template words and meanings which may be in the input text, rather than an overall intent of an input query. The present model is also given words or phrases which can be used anywhere in the trained variances in order to weight the prediction of certain intents more positively if these token sequences are detected in the input. Synonymous terms and phrases can also be defined to reduce the number of training variances required, and provide entity detection in a given input token sequence.

Different human users may use different language to express the same intent. For example, to request a phone reboot, a user might say:
“I need to do a phone reboot”
“My phone won't restart”
“Please tell me how to reboot my phone” etc.

The AI model is trained to classify each of these variances onto the same intent (in this case “phone reboot”). The training model of such models is a non-trivial exercise where there may be a significant variance both in mapping queries to intents, and in the nature of the queries and intents.

The Smart Mesh system is a learning model for artificial intelligence (AI) assistants (sometimes referred to as virtual assistants or chatbots) with applications in a wide variety of contexts. The Smart Mesh system is particularly well suited to industries where there is a high degree of common language and actions, such as the public sector; for example, the system is well suited to training virtual assistants such as chatbots on the websites of organisations such as universities, councils or government agencies. The described embodiments also have applications for chatbots in healthcare, education, and many other industries. In this particular context, the term “industry” is used to denote categories of contexts which are defined in a “vertical mesh”. A “vertical mesh” will be described in more detail herein. Other contexts relate to functions or services which can be provided across different industries, and these are delivers in a so-called “horizontal mesh”. An IT support function would be an example of a function trained in a horizontal mesh. The challenge in all of these contexts is to provide a chatbot offering a “human parity experience”, wherein a human user has a similar experience communicating with the AI chatbot compared to communicating with a human assistant. The success of the chatbot in achieving human parity can be measured through user outcomes, for example by requiring an average resolution rate for user queries made to the chatbot which is improved over analogous conversations with human respondents.

The Smart Mesh provides a solution to this challenge by using a new method for training the AI language model underpinning a chatbot assistant.

The Smart Mesh learning model for an AI assistant is able to provide the specialised services of a Stand Alone model 120, but emulates the benefits of a large training data set displayed by the centralised learning model 100. As will now be described in detail, this is achieved by connecting the AI assistant for a specific organisation to other, similar AI assistants, owned by other organisations, by means of a smart learning mesh. In this description, the word ‘organisation’ is used to denote a group of humans and computer systems which operate in one or more contexts, in which a context defines a particular set of intents that an AI assistant has to discern from a human user. In particular, an organisation provides functions and services of the organisation that can be accessed through user computer devices. An organisation may comprise computer systems and human users, and be capable of delivering answers and carrying out organisational actions responsive to discerned intents.

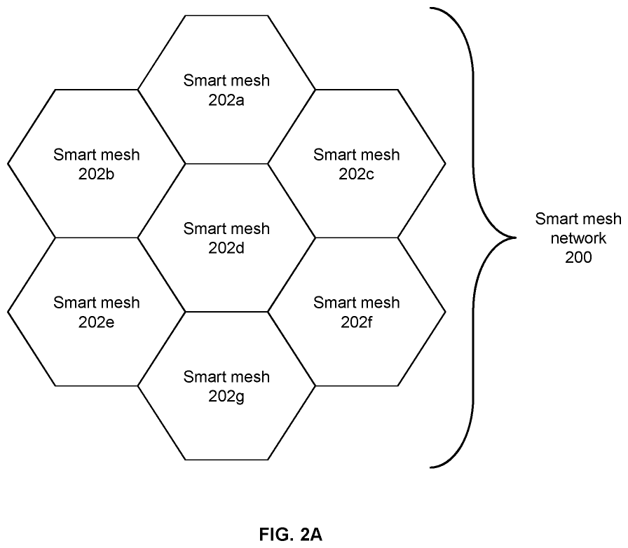

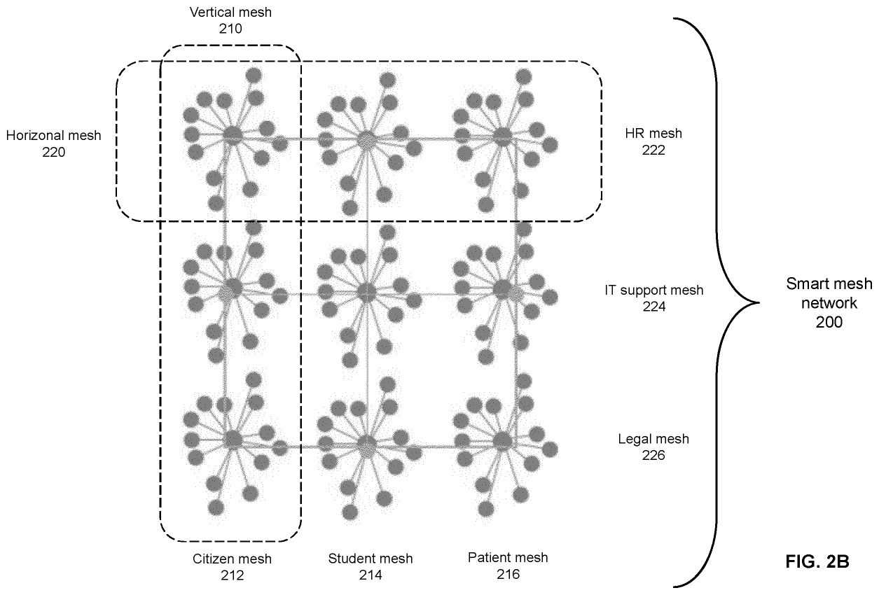

FIG. 2A shows a schematic of an example smart mesh network 200 comprised of smart meshes 202a-202g. An organisational AI assistant is assigned to at least one smart mesh 202a based on manually identified contexts of the application of that organisational AI assistant. FIG. 2B shows that the smart mesh network 200 comprises two type of mesh: vertical meshes 210 and horizontal meshes 220. A vertical mesh 210 comprises industrial specific contexts; for example, a citizen mesh 212, student mesh 214 or patient mesh 216. A horizontal mesh 220 comprises function specific services which will be common to each industry; for example, a HR mesh 222, IT support mesh 224 or legal mesh 226. Each smart mesh 202a-202g therefore comprises multiple AI assistants owned by different organisations but with a shared industrial or functional context. The smart mesh network 200 then comprises the complete set of all vertical meshes 210 and horizontal meshes 220.

In the Smart Mesh learning model, the functions of an organisational AI assistant are performed in a virtual assistant platform using multiple machine learning models which are combined by a parent model. These comprise a generic language model; a master mesh language model; and a client language model. In certain embodiments, the platform additionally comprises an Ethics model and a Smalltalk model. These are non context-specific models, but which offer specialist capabilities which are useful in all contexts. The client language model is specific to the context of the organisational AI assistant, and is solely owned and used by a particular organisation, in a manner akin to a Stand Alone model 120. An important difference to a Stand Alone model 120 is that the client language model is used in conjunction with the generic model and the mesh model (and the Ethics and small talk models when present) to deliver chatbot functionality to a particular user in that organisation.

When an organisation decides to implement a chatbot, a request is passed to a computer system which provides virtual assistant platforms. Note that this request is from a client computer in the organisation and is distinct from the user request or query. The computer system comprises one or more hardware processors which are capable of executing computer readable instructions, and one or more computer memory for storing a program comprising the instructions to be accessed and executed by the one or more processor. The computer system instantiates a new client language model for the context of the organisation by calling an instance of the stored program for execution by the one or more processor. Note that an organisation may have more than one context. An organisation is likely to operate only in a single industry (although some organisations might operate in multiple industries) and therefore belong to only one vertical mesh 210, but it is likely than an organisation will require more than one function/service to be delivered, and thereby belong to more than one horizontal mesh 220. In any event, the request defines the industry and/or the function for which the particular chatbot is to be set up. For example, the request may be for a chatbot to support an IT function in healthcare. The new client language model is initially set up using a generic language model, a master mesh language model and a client specific language model. Note that on instantiation, the client specific language model may be entirely untrained. The generic language model will have been trained on generic non-specialist language, and could include generic basic intents such as “how do I . . . ” and “I want to . . . ”. The master mesh language model will have been trained on a particular smart mesh 202a specific to the industry or function, including queries and intents. By using the intermediate smart mesh layer, a new client language model may be instantiated with around 80% of functionality already embedded. Thus, the organisation only needs to train an additional 20% or so functionality into the model using its own local data. This significantly reduces the size of the dataset which is needed at the organisation to successfully train a new client language model for its particular context. On instantiation, it is determined to which smart mesh 202a-202g the new client language model belongs, based on its context. For example, if the organisation is in healthcare, the new client language model could be assigned to a vertical patient mesh 216. If the new client language model is to support IT functions, it is also assigned to a horizontal IT support mesh 224. All organisation on a particular smart mesh 202a share a common language model (the master mesh language model for that mesh).

The language models utilised comprise multiple classification machine learning (MCML) models applied to achieve natural language processing. The MCML models are trained by means of a supervising learning process in which the model is trained using request and action pairs. The majority of pairs in the set are typically in the form of question and answer combinations, which provide the context to be able to define intent labels for the questions. The labelling process is undertaken by a language modeller, and requires decisions regarding duplicate intents, granularity of the intents and necessary compromises to accommodate, for example, intents which are too similar. The MCML models are thus trained to classify query variances as intents.

As described in the following, an intent represents a task or action a user wishes to perform, or a request for information. An intent must be assigned a unique label by the supervising language modeller; it may then be added to the model. Variances are possible statements associated to an intent; for example, a range of ways in which a human user could pose a question regarding an intent. Having identified an intent and a variance in a user input, the model is configured to provide an appropriate response within the client's virtual assistant implementation. Intents and variances can be either general (i.e. used by more than one organisational AI assistant) or owned by the organisation, but responses are always ‘owned’ by the organisation. This is achieved by storing an intent mapping data structure for each organisation, which maps intents to technical actions, where technical actions can be used to deliver responses.

Every organisational AI assistant allocated to a given smart mesh 202a has access to a master mesh language model associated with that the smart learning mesh. The master mesh language model comprises intents and variances which are applicable to all organisational AI assistants allocated to the smart mesh 202a. The following table displays the number of pre-trained intents and variances typically available on example smart mesh 202a implementations. These are available to a client organisation without any pre-training on the part of that organisation.

| | Pre-trained | Pre-trained |
|---|---|---|
| | Intents | Variances |
| Vertical mesh 210 models | | |
| Local Government | 930 | 13950 |
| University Students | 850 | 11050 |
| College | 500 | 7500 |
| Mental Health | 100 | 1300 |
| Government Customer Services | 100 | 1300 |
| Horizontal mesh 220 models | | |
| IT Support | 370 | 5550 |
| Human Resources | 900 | 4500 |
| Chitchat | 9000 | 600 |
| Ethics | 150 | 2250 |

The intents available in a master mesh language model can themselves be categorised by theme. For example, the following table shows the number of pre-trained intents available for given themes within the University Students mesh. Where appropriate, themes present in the language model for a smart mesh 202a may be used to implement sub-mesh boundaries within that smart mesh.

Themes could be thus used to subdivide a mesh into sub-meshes. Sub-meshes could be associated with their own respective data pools, and be subject to training processes as described for a mesh. Once a sub-mesh has been trained, certain trained intents may be used to update the mesh model of the mesh of which a sub-mesh forms a part.

| Intent theme in University Students mesh | Number of available intents |
|---|---|
| Academic Study | 138 |
| Arrival and Admissions | 62 |
| Campus/Fees/Admissions | 1 |
| Campus & IT | 56 |
| Careers | 16 |
| Catering & Retail | 34 |
| Complaints | 3 |
| Covid | 41 |
| Crisis | 8 |
| Directions & Wayfinding | 3 |
| Everyday Life | 23 |
| Fees & Funding | 49 |
| Forms & Processes | 29 |
| Incidents | 1 |
| International | 8 |
| IT Queries | 36 |
| Libraries | 22 |
| Local Knowledge | 12 |
| Personal Support | 48 |
| Registration & Student Record | 54 |
| Safety & Security | 9 |
| Student Finance | 18 |
| Student Support | 106 |
| Timetabling | 28 |
| Travel | 20 |
| Union | 2 |
| Who's who | 13 |

Within any smart mesh 202a, the shared master mesh language model is configured to seamlessly integrate with the exclusive client language model of the organisational AI assistant. This integration is achieved by the parent model. The parent model is a model which contains all variances from the consistent “child” models. When an input is sent to the parent model, the parent model will return ranked confidence scores from all intents across the child models. The confidence scores of all intents aggregated into the parent model are then compared equally to obtain ranked confidence scores, which are used to determine the intent best suited to resolving a user's query. The individual language models therefore respond to the query as if they were one single model.

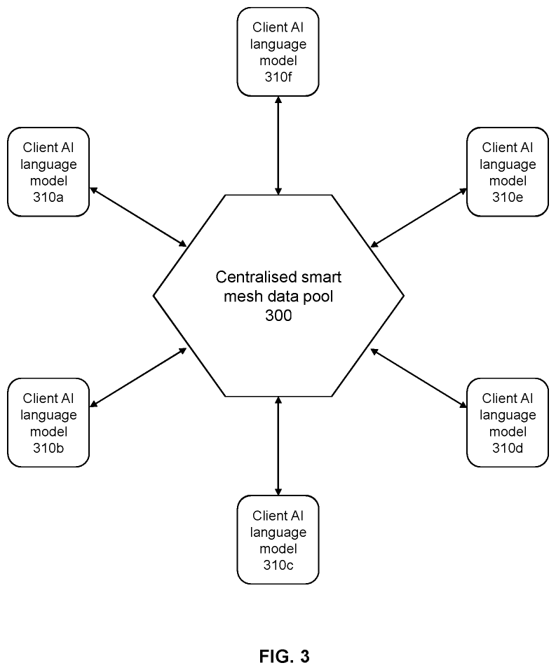

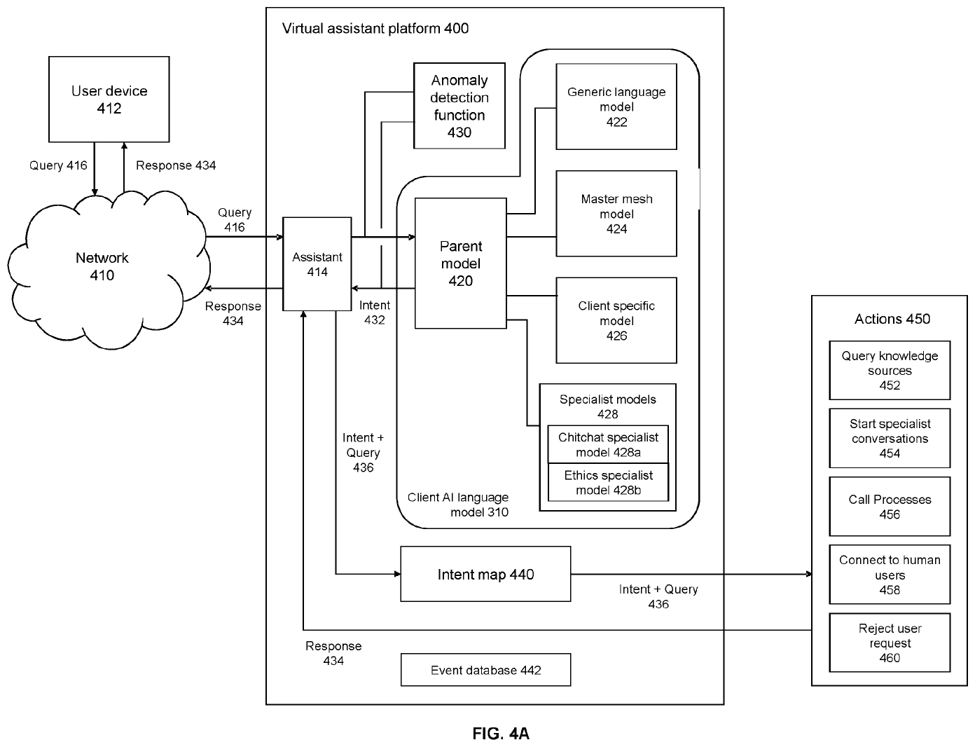

FIG. 3 is a schematic diagram illustrating how a plurality of client AI language models supply data to a centralised smart mesh data pool 300 for training purposes. In FIG. 3, each client AI language model 310a, 310b . . . 310f all belong to the same mesh.

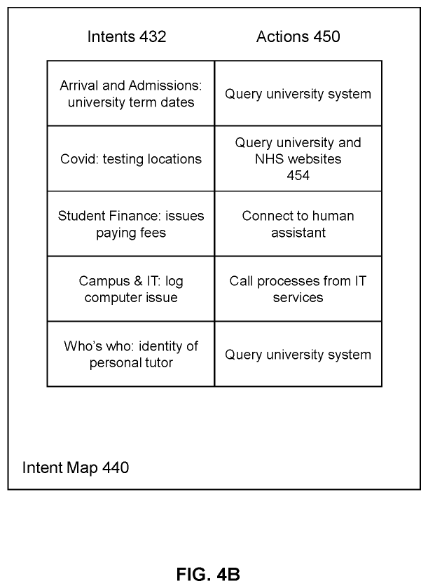

FIG. 4 is a schematic block diagram illustrating use of a chatbot such as client AI language model 310 provided by a virtual assistant platform 400. As described above, the client AI language model 310 comprises a parent model 420 which combines a generic language model 422, a master mesh model 424, a client specific model 426 and one or more specialist models 428. In the particular example which is illustrated in FIG. 4, there is a chitchat specialist model 428a and an ethic specialist model 428b. The chitchat specialist model 428a is sometimes referred to herein as the small talk model.

The virtual assistant platform 400 further comprises an anomaly detection function 430 which is described in more detail later. In FIG. 4A, reference numeral 412 denotes a user device which comprises the user interface 132 described above with reference to FIG. 1C to use the chatbot provided by the client AI language model 310. The user device 412 receives a query 416 from a user as has been described. Query 416 is communicated to an assistant 414 at the virtual assistant platform 400 via a communications network which could take any appropriate form. Note that FIG. 4 illustrates a cloud-based solution where a user device is implemented locally and the virtual assistant platform 400 is implemented by one or more computers operating remotely. The communication network could for example be the Internet. The query is communicated via a network session which has been opened between the user device and the virtual assistant platform, for example using API protocols, the query may be delivered over an HTTPS session using TCIP protocols. It may be tagged with a unique query identifier.

The assistant 414 supplies the query 416 to the parent model 420 which has aggregated each of the generic language model 422, the master mesh model 424, the client specific model 426 and the one or more specialist models 428. The parent model 420 attempts to classify the incoming query 416 and generates an output which represents the highest confidence output returned by the child models. Each output defines an intent 432. An intent 432 defined by the chitchat specialist model 428a is categorised as a “smalltalk intent”, and an intent 432 defined by the ethics specialist model 428b is categorised as a “sensitive intent”. Such intents are handled in the same manner as for any other intent. Some examples of smalltalk intent and sensitive intent are given later.

The assistant 414 performs further analysis of the query 416 to generate linguistic metadata before passing the combined query+intent 436 to an intent map 440. The combination of query+intent 436 is passed to the intent map 440 since query 416 may contain codified instructions directing the user's intent 432. For example, in the query “ask HR when my next performance review is”, the intent is the date of the user's next performance review, but the direction to ask HR remains an important input to the mapping decision to be made by intent map 440. The intent map 440 is unique to the client's assistant implementation and allows the assistant 414 to decide how to process the query in a manner specific to the organisation. One or more actions 450 will be invoked depending on the mapping configured. FIG. 4B displays an illustration of example content of the intent map 440 for a University Students mesh, in which intents 432 are paired with actions 450. Each action 450 is associated with a response 434 which the assistant 414 transmits to the user device 412. Note that the actions associated with each particular intent 432 for a particular client could also be stored at a central computer system, on a virtual assistant platform 400, or associated with the virtual assistant platform 400. However, these actions are specific to the organisation for which the chatbot was delivered.

A response 434 generated after an action is executed might be an answer to a question, a question to gather more information, some electronic media, or an indication that some process has been invoked or completed. In all cases, the actions 450 that are invoked are specific to the organisation for which the assistant was delivered. In the particular example which is illustrated in FIG. 4, the actions 450 may comprise querying of knowledge sources 452, starting specialist conversations 454, call processes 456, connection to human users 458 and rejecting user requests 460.

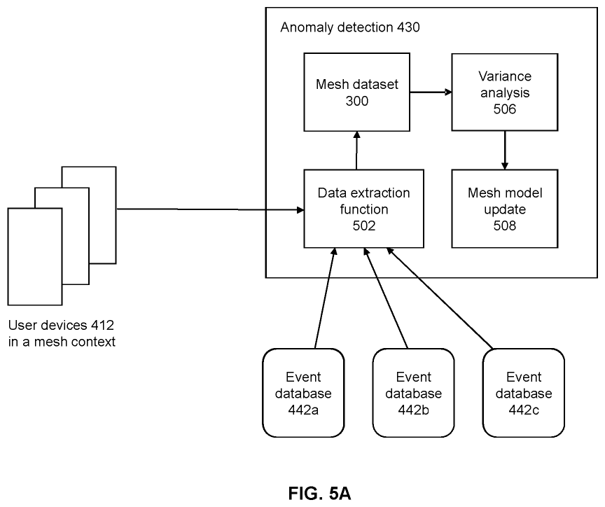

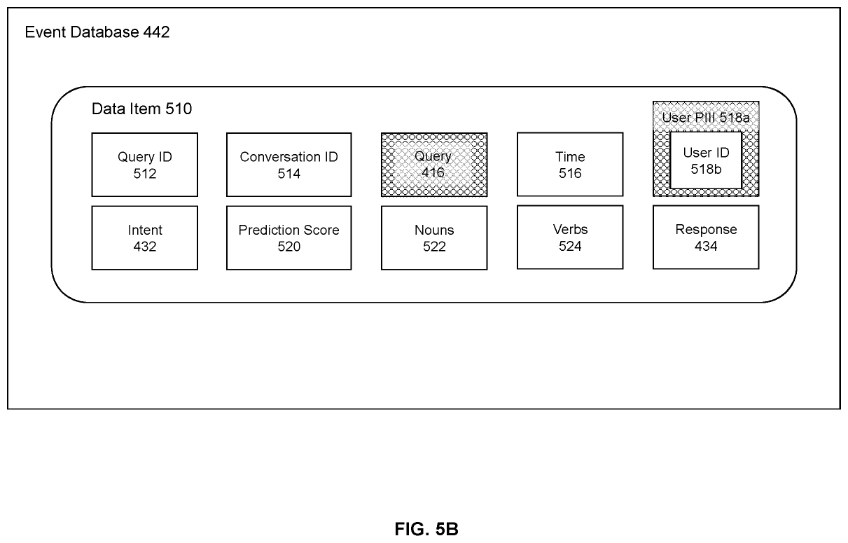

The smart mesh learning process harvests anonymised data from all the AI assistants in a particular mesh to the centralised smart mesh data pool 300 associated with that mesh. Reference is made to FIG. 5 later to describe the harvesting process, but it is important to note that the process can involve anonymising data which has been logged by the virtual assistant platform in a client event database 442. A record is written to the event database 442 for each user query 416 submitted to the virtual assistant platform 400. The record is updated as it is processed by the virtual assistant platform 400 to allow the processing and outcomes of the query 416 to be tracked by the system. The following table illustrates some of the data which could then be pulled from each client's event database 442 to the centralised smart mesh data pool 300.

| Field | Example | Description |
|---|---|---|
| Query ID | D38C975A-B3CF-49BF-8071- | Unique query ID |
| | 2116CEE80201 | |
| Conversation ID | 3nYgnaTBYOpKUKiQgojQel-m | Unique conversation session |
| | | ID for the user with the |
| | | assistant |
| Query | How do I check my rent? | Query submitted by user. |
| | | Personally identifiable |
| | | information (PII) in the |
| | | query is removed when |
| | | mesh pulls the record from |
| | | the client's event database. |
| Time | 2021-05-28 14:31:03.610 | Time of query |
| User ID | Bob.Smith@somegreatcompany.co.uk | User identifier. PII is |
| | | removed when mesh pulls |
| | | the record from the client's |
| | | event database. |
| Intent | LocalGov.Housing.Rent.Account.Manage | Intent label of the highest |
| | | scoring prediction |
| Prediction Score | 0.8950357 | Confidence score (0.0-1.0) |
| Nouns | rent rents | Pertinent plural and singular |
| | | nouns extracted from the |
| | | query |
| Verbs | check | Pertinent verbs extracted |
| | | from the query |
| Response | You can manage your rent account online. | Truncated form of the |
| | Once you have registered, you can see | response given to the user |
| | your transactions, check your balance and | |
| | pay your rent. Registration is quick and | |
| | easy and all you will need is your payment | |
| | reference number handy; this will start | |
| | with D(14), I(15), F(16) or H(18). If you | |
| | need help with your online rent account | |
| | please call the Customer Payment and | |
| | Debt Team on 000 0000 0000 or email | |
| | ‘cpd.general@somecity.gov.uk’ | |

AI is used to analyse the data pool for new anomalies and trends which are categorised and then actioned by a human in the loop. The master mesh model 424 is then updated and retrained with learned content. FIG. 5A shows the anomaly detection function 430 in more detail. The anomaly detection function 430 comprises a data extraction function 502. The data extraction function 502 extracts data from event databases 442a-442c, where an event database 442 is associated with each client-specific instance of the virtual assistant platform 400. The data extraction function 502 is responsible for extracting data from the event databases 442a-442c and generating anonymised data to be stored in the centralised smart mesh data pool 300. FIG. 5B illustrates an example format of a data item 510 which may be logged in an event database 442. Data item 510 may include a user query 416, an intent 432 generated by the client AI model 310, and a response 434 generated from the client specific actions 450. Data item 510 may also include: a query ID 512; a conversation ID 514; a time 516 at which the conversation occurred; a user PII 518a and user ID 518b; a prediction score 520; nouns 522 extracted from the query 416; and verbs 524 extracted from the query 416. Any fields within the logged data item 510 which denote personal information or other identifying characteristics may be processed in the data extraction process to generate anonymised data items to be stored in the mesh dataset. These items include the query 416 and user PII 518a, which are shown cross-hatched in FIG. 5B for ease of reference. For example, the query 416 may contain user specific information, such as name and address, which is not relevant to the intent 432. Such PII is removed before passing the data item to the smart mesh pool. A user ID may contain PII such as an email address. This may be removed—or a hashed version may be provided to generate a hashed user ID.

Note that the data extraction function 502 supplies data to the centralised smart mesh data pool 300 only for instances of the virtual assistant platform 400 which are operating in a particular smart mesh 202a. Each centralised smart mesh data pool 300 is specific to its own mesh. In one embodiment, there is a data extraction function 502 which operates for each individual centralised smart mesh data pool 300 which extracts data only from event databases 442 from instances of the virtual assistant platform 400 operating in that mesh. In other embodiments, there is a global data extraction function 502 which extracts data (and anonymises it) from all event databases 442 which are operating across all meshes, but which stores the anonymised data that it generates only into the centralised smart mesh data pool 300 of the specific mesh in which that instance of the virtual assistant platform 400 is operating. That is, the centralised smart mesh data pool 300 is specific to virtual assistant platforms 400 operating on that mesh only.

FIG. 5A shows that the anomaly detection function 430 comprises a variance analysis function 506 which analyses data in the centralised smart mesh data pool 300. A mesh model update function 508 can update the master mesh model 424 for that mesh based on the variance analysis 506 as described further herein.

Examples of applications of AI assistance in the public sector include the following.

A chatbot may provide mental health assistance in healthcare.

A chatbot may provide responsive to local government questions through a council website.

A chatbot may provide assistance for the Information Commission Office by dealing with requests for GDPR compliance.

A chatbot may provide assistance for university students.

A chatbot may provide assistance with IT and HR queries for the Crown Prosecution service.

These are only a few examples of a very diverse possibility of applications for chatbots. Other areas of applications include universities and colleges, healthcare, mental health, central governments, pleas, power self service automation, virtual assistant, employee communications, HR and wellbeing, IT support, local government and housing associations.

The virtual assistant platform described herein provides AI assistants who present a single point of communication with a user to enable context driven response and actions to be provided. The chatbot is capable of intelligently triaging and routing intents to other bots, live chat, phone or services or actions such as booking appointments etc. The chatbot may provide insights into the needs of service users and the performance of service delivery. The chatbot may have a dedicated ethical AI compliance sub-system to ensure that ethical values are maintained. The user experience may be tailored to a particular need and a particular device.

The following table provides useful definitions for understanding the present description, along with specific examples and the owner. Note that here a hyper-vendor comprises an external organisation capable of providing cloud scale natural language processing.

| NLP Term | Description | Example | Owner |
|---|---|---|---|
| Intents | A unique root answer or action | Covid-19 symptoms | Client |
| | | are . . . | |
| Variances | Possible questions or statements | I am 32, what are the | Client |
| | associate to an intent | covid-19 symptoms? | |
| Speech | Recognition of speech | Hello = greeting | Hyper-vendor |
| recognition | | | |
| Text | Identify entities or sentiment in | Human being = person | Hyper-vendor |
| analytics | speech | | |
| Translation | Language translation services | Ciao = Hello in English | Hyper-vendor |

A variety of different anomalies may be detected.

One type of anomaly is that a new intent is needed. That is, the intent 432 which is intended by the user either cannot be derived from the request which has been inputted by a user, or the incorrect intent is derived from the request. When a new intent 432 is needed, the master mesh model 424 may be trained to classify that intent from incoming requests.

An intent 432 may need updating. That is, the AI models are correctly classifying the input requests and mapping them to a correct intent 432, but the intent 432 is no longer applicable in the particular context represented by the client uses.

A new intent variance may be needed. That is, users may begin to express their request for a particular intent 432 in different ways. When it is noted that a new variance should be mapping onto a particular existing intent 432, the machine learning model may be trained appropriately.

A response update may be needed. That is, it may be noted that users are not satisfied with the particular response 434 even if the response 434 was correct and the response 434 mapped to the intent 432. Changes in the context may require that the response 434 associated with the technical action of a particular intent 432 is updated.

Anomalies associated with the specialist models 428, such as the chitchat specialist model 428a or ethical specialist model 428b, may include the fact that new small talk is needed. The chitchat specialist model is trained to recognise ‘banter’ unlikely to be relevant to a particular intent. For example:

“Who is your boss?”

“Are you going to the party tonight?”

For the ethical model, it may detect a valid ethical breach or an invalid ethical breach as anomalies. The ethical model is trained to recognise issues that do not express an organisational intent, but which instead may represent a breach of welfare or legal circumstances.

For example:

“I want to throw myself off a bridge—where is the nearest bridge?”

The ethical model output will prevent this being mapped to an action to search for local bridges.

User sentiment may be detected; for example, detection of an anomaly may constitute the detection of frustration in a user who is unable to have his needs satisfied by the chatbot.

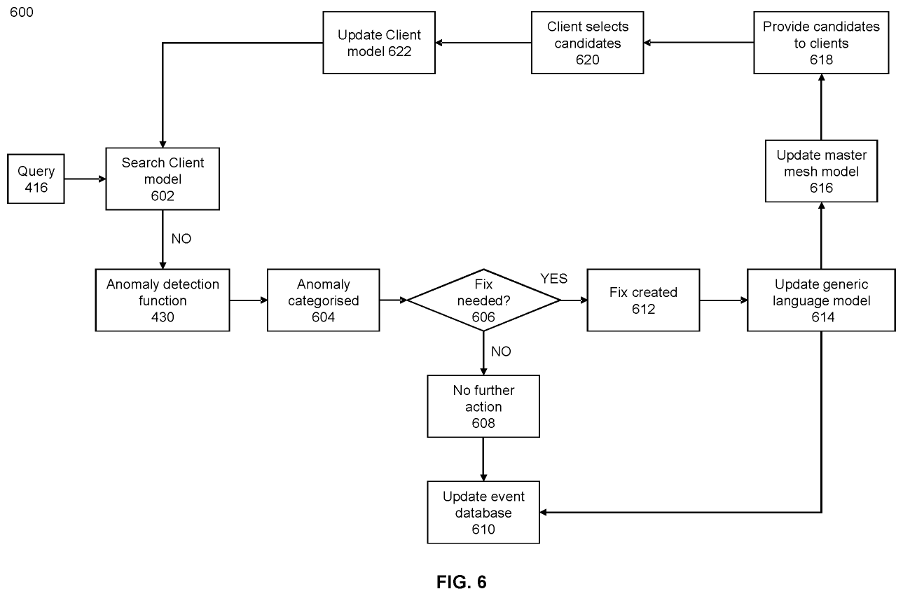

FIG. 6 illustrates a flow diagram 600 for updating the client models. As explained with reference to FIG. 4, a query 416 is received at the client AI language model 310. The parent model searches the client model at step 602 and applies the query 416 to each of the generic language model 422, master mesh model 424 and client specific model 426 (and the specialist language models 428 if present) to determine if the query 416 can be classified as an intent 432. If it can, it is returned as described above with reference to FIG. 4. If it cannot, the process proceeds to the anomaly detection function 430. The anomaly is categorised, for example to detect one or more of the above described anomalies, at step 604, and then it is determined at step 606 whether or not a fix is needed. If no fix is needed, at step 608 no further action is taken and an event database is updated at step 610. The relevant entry in the centralised smart mesh data pool 300 would also be updated so as to remove it from the list of anomalies. If at step 604 it is determined that a fix is needed, a fix is created at step 612. The creation of a fix may involve both software and human involvement to address the anomaly, depending on the category of the anomaly. The generic language model 422 is updated at step 614 if required, and the master mesh model is 424 updated at step 616. Note that the anomaly detection and resolution process described herein is iterative, in that the portion of the data pool being examined must be examined both in a serial fashion and holistically. This is since some anomalies will not be apparent without taking into account the frequency of queries which are considered similar to query 416.

Following approval by each individual client, each client's local AI model is updated, retrained and tested.

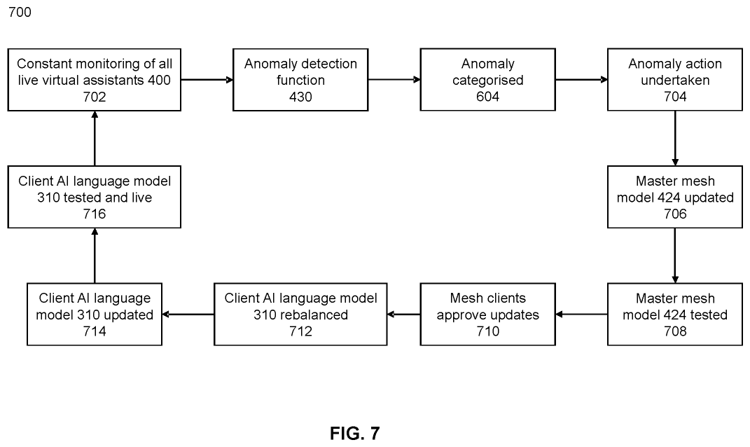

FIG. 7 displays a flowchart 700 for the updating of a client's AI language model 310. Constant monitoring of all live virtual assistants 400 owned by the client is conducted at step 702. At defined points in time the anomaly detection function 430 is performed using latest snapshots of the client event data, the data having been anonymised by the data extraction function 502 as they are pulled into the centralised smart mesh data pool 300. When anomaly detection function 430 detects an anomaly, anomaly categorisation 604 occurs and an anomaly action is undertaken at step 704 in the manner described previously by flowchart 600. As a result, the master mesh model 424 is updated by function 706. The updated master mesh model 424 is then tested at step 708; testing is necessary to ensure that changes to the shared master mesh model 424 do not impact negatively on the functionality of a client's AI language model 310.

To this end, mesh clients are provided with information regarding the testing outcomes. The mesh clients then approve updates at step 710 if the outcomes are positive. Following client approval of updates, the client AI language model 310 is rebalanced at step 712; rebalancing ensures that the updates to master mesh model 424 do not affect the specific functionality of a client's specific model 426. Some adjustments to client specific model 426 may be necessary to achieve this. Once rebalancing is accomplished the client AI language model 310 is updated at step 714, and then tested and made live to users at step 716. Once an update is made constant monitoring of all virtual assistants 400, step 702, resumes, and hence flowchart 700 is displayed as a continuous loop.

1. A virtual assistant platform implemented by a computer system comprising:
one or more hardware processors configured to execute computer readable instructions;
one or more memory storing the instructions;
a mapping data structure stored in the one or more memory, the mapping data structure mapping a plurality of intents to respective client specific actions;
a network interface configured to receive a query from a user device operating in a client specific communication session with a virtual assistant in a first context, the instructions when executed providing: an AI language model comprising:
a client specific language model, the client specific language model having been trained on client specific data;
a mesh language model, the mesh language model having been trained on mesh specific data, the mesh specific data having been received by operating multiple virtual assistants in the first context, the AI language model being responsive to the query to generate an intent;
a mapping function to apply the intent to the mapping data structure and access a corresponding client specific action for delivery of a response to the user device; and
a transmission function to transmit the response to the user device.

2. The virtual assistant platform of claim 1, wherein AI language model comprises a generic language model, the generic model having been trained on general, non context-specific data, the non context-specific data having been received from multiple virtual assistants operating in different contexts.

3. The virtual assistant platform of claim 1, wherein the AI language model comprises an ethics model trained to recognize queries requiring an ethics response.

4. The virtual assistant platform of claim 1, wherein the AI language model comprises a small talk model trained to recognize queries relating to small talk for which no intent is applied to the mapping data structure.

5. The virtual assistant platform of claim 1, wherein the instructions, when executed, provide a data extraction function which accesses query related data stored in a logging database and removes any personal identifiers from the data.

6. The virtual assistant platform of claim 5, wherein the instructions, when executed, provide a data storage function which stores the anonymized data in a mesh data pool specific to the first context.

7. The virtual assistant platform of claim 6, wherein the instructions, when executed, extract data from a plurality of logging databases, each logging database holding data specific to a client, the clients all belonging to the first context.

8. The virtual assistant platform of claim 7, wherein the instructions, when executed, cause data to be extracted from a second plurality of logging databases, each logging database of the second plurality being associated with clients operating in a second context, and to store anonymized data from the second plurality of logging databases in a second mesh data pool.

9. The virtual assistant platform claim 1 in which the instructions, when executed, provide an analytics function which analyses the anonymized data in the one or more mesh data pool, determines when retraining of the mesh language model is required, and, when determined, causes the mesh language model to be retrained and updated.

10. A method of configuring a set of virtual assistants assigned to a common context and operating at different client locations, the method comprising:
monitoring operation of the set of virtual assistants, each virtual assistant configured to receive a query from a user and generate an intent derived by natural language processing of the query, by a client specific machine learning model and a context specific machine learning model, the client specific model having been trained on client specific data while operating at a client location, and the context specific model having been trained on context specific data received from multiple virtual assistants operating in the context;
detecting one or more anomaly from one or more of the virtual assistants;
categorizing the anomaly;
retraining the context specific machine learning model to remove the anomaly; and
delivering the retrained context specific machine learning model to each of the set of virtual assistants.

11. The method of claim 10, further comprising configuring a second set of virtual assistants operating in a second common context, the method comprising:
operating the virtual assistants of the second set in the second context;
determining one or more anomaly from one or more of the virtual assistants of the second set;
categorizing the one or more anomaly detected from the virtual assistants of the second set;
retraining a second context specific machine learning model specific to the second common context to remove the anomaly; and
delivering the retrained second context specific machine learning model to each of the second set of virtual assistants.

12. The method of claim 11, wherein the step of monitoring operation of the first and second sets of virtual assistants comprises logging user queries in association with responses from the respective virtual assistant models for each context, and generating a first dataset of queries and responses for the first context and a second dataset of queries and responses for the second context of virtual models.

13. The method of claim 10, comprising, prior to the step of delivering the context specific machine learning model, the step of providing a candidate update to a client location and receiving selection of one or more candidate updates from the client location.

14. The method of claim 10, wherein the step of categorizing the anomaly comprises at least one of:
identifying that a new intent is needed;
identifying that an existing intent needs updating;
identifying that a new intent variance of a query is needed; identifying that an answer update is needed;
and detecting that there has been an ethical breach.

15. (canceled)

16. (canceled)

17. The method of claim 10, comprising transmitting an intent output from a virtual assistant model to a client location and receiving an answer from that client location and delivering the answer to the user.

18. (canceled)

19. The method of claim 10, wherein each virtual assistant comprises an ethics module configured to manage the ethical behavior of the virtual assistant.

20. (canceled)

21. The method of claim 10, wherein the step of categorizing an anomaly comprises identifying that frustration of a user has been detected by natural language processing of the user queries.

22. The method of claim 10, wherein each virtual assistant model comprises a generic model, the generic model having been trained on general non context-specific data received from multiple virtual assistants operating in different contexts.

23. A method according to claim 10, comprising receiving a request to instantiate a context specific virtual assistant;
delivering a context specific virtual assistant comprising a generic model, the generic model having been trained on general non context-specific data received from multiple virtual assistants operating in different contexts and a context specific model; and
training the instantiated virtual assistant on client specific data.

24. The method of claim 23, comprising allocating the instantiated virtual assistant to at least one of a horizontal mesh and a vertical mesh, the vertical mesh comprising a plurality of industry specific contexts and the horizontal mesh comprising a plurality of function specific contexts.
